(19) United States
(12) Patent Application Publication
(10) Pub. No.: US 2012/0152970 A1
(43) Pub. Date: Jun. 21, 2012

(54) Product Dispensing System

(76) Inventor: Laurel Thomas, Richmond, VA (US)

(21) Appl. No.: 12/970,683

(22) Filed: Dec. 16, 2010

(51) Int. Cl. B65D 83/00; B65G 59/00

(52) U.S. Cl. 221/1; 221/282

(57) ABSTRACT

A product dispensing system including a container that defines an internal volume and an opening into the internal volume, and a dispenser that includes a frame including an upper support deck having a front end and a rear end longitudinally opposed from the front end and a catch element including a base connected proximate the front end and a protrusion extending from the base toward the rear end such that the protrusion engages the opening when the container longitudinally moves along the upper support deck from the rear end toward the front end.

### FIELD

This application relates to the dispensing of products from packaging containers and, more particularly, to product dispensers configured to cooperate with packaging containers to dispense products.

### BACKGROUND

Products are typically shipped to retailers in bulk by enclosing multiple individual product units in a container, such as a carton or box. For example, canned foods may be shipped to a retailer in a box containing twenty-four individual cans. Then, it is typically the retailer's obligation to remove the individual product units from the container and present them (e.g., on a shelf) to consumers.

Alternatives to the traditional package-ship-unpack-display model are being developed in an effort to improve operating efficiency. For example, U.S. patent application Ser. No. 12/777,444 filed on May 11, 2010, the entire contents of which are incorporated herein by reference, discloses a new system for dispensing and displaying products packaged in a container. Specifically, the system includes a frame having a support structure, a product display area and an opening tool. The frame may be positioned on a retailer's shelf and loaded with product simply by placing a container comprising multiple units of product onto the support structure of the frame. As the container is being placed onto the support structure, the opening tool of the frame opens the container in such a manner that product rolls from the container and down to the product display area of the frame under the force of gravity.

Despite advances already made in the field, those skilled in the art continue with research and development efforts directed to apparatus and systems for dispensing products from packaging containers.

### SUMMARY

In one aspect, the disclosed product dispensing system may include a container that defines an internal volume and an opening into the internal volume, and a dispenser that includes a frame including an upper support deck having a front end and a rear end longitudinally opposed from the front end and a catch element including a base connected proximate the front end and a protrusion extending from the base toward the rear end such that the protrusion engages the opening when the container longitudinally moves along the upper support deck from the rear end toward the front end.

In another aspect, the disclosed product dispensing system may include a dispenser including a frame having an upper support deck that defines a front end and a rear end longitudinally opposed from said front end and a catch element connected to the front end and including a protrusion that extends toward the rear end at a non-zero angle relative to the upper support deck, and a container positioned on the upper support deck, wherein the container defines an internal volume and an opening into the internal volume, the opening being positioned to be engaged by the protrusion when the container longitudinally moves along the upper support deck from the rear end toward the front end.

In yet another aspect, disclosed is a method for dispensing a plurality of products. The method may include the steps of (1) providing a dispenser that includes a frame including an upper support deck having a front end and a rear end longitudinally opposed from the front end and a catch element connected proximate the front end, the catch element including a protrusion that extends toward the rear end, (2) providing a container housing the plurality of products, the container defining an opening therein, (3) sliding the container longitudinally along the upper support deck toward the front end such that the protrusion engages the opening and opens the container, and (4) sliding the open container longitudinally along the upper support deck toward the rear end to allow the plurality of products to be at least partially dispensed from the open container.

Other aspects of the disclosed product dispensing system and associated method will become apparent from the following detailed description, the accompanying drawings and the appended claims.

### BRIEF DESCRIPTION OF THE DRAWINGS

FIG. 1 is a side elevational view, partially in section, of one aspect of the disclosed product dispensing system, shown with the container removed from the dispenser;

FIG. 2 is bottom perspective view the container of the product dispensing system of FIG. 1;

FIG. 3 is a side elevational view, partially in section, of a portion of the dispenser of the product dispensing system of FIG. 1;

FIG. 4 is a side elevational view, partially in section, of the product dispensing system of FIG. 1, shown with the container at a first stage of engagement with the dispenser;

FIG. 5 is a side elevational view, partially in section, of the product dispensing system of FIG. 4, shown with the container at a second stage of engagement with the dispenser;

FIG. 6 is a side elevational view, partially in section, of the product dispensing system of FIG. 5, shown with the container at a third stage of engagement with the dispenser; and

FIG. 7 is a side elevational view, partially in section, of a portion of the product dispensing system of FIG. 6, shown with the container at a fourth stage of engagement with the dispenser.

### DETAILED DESCRIPTION

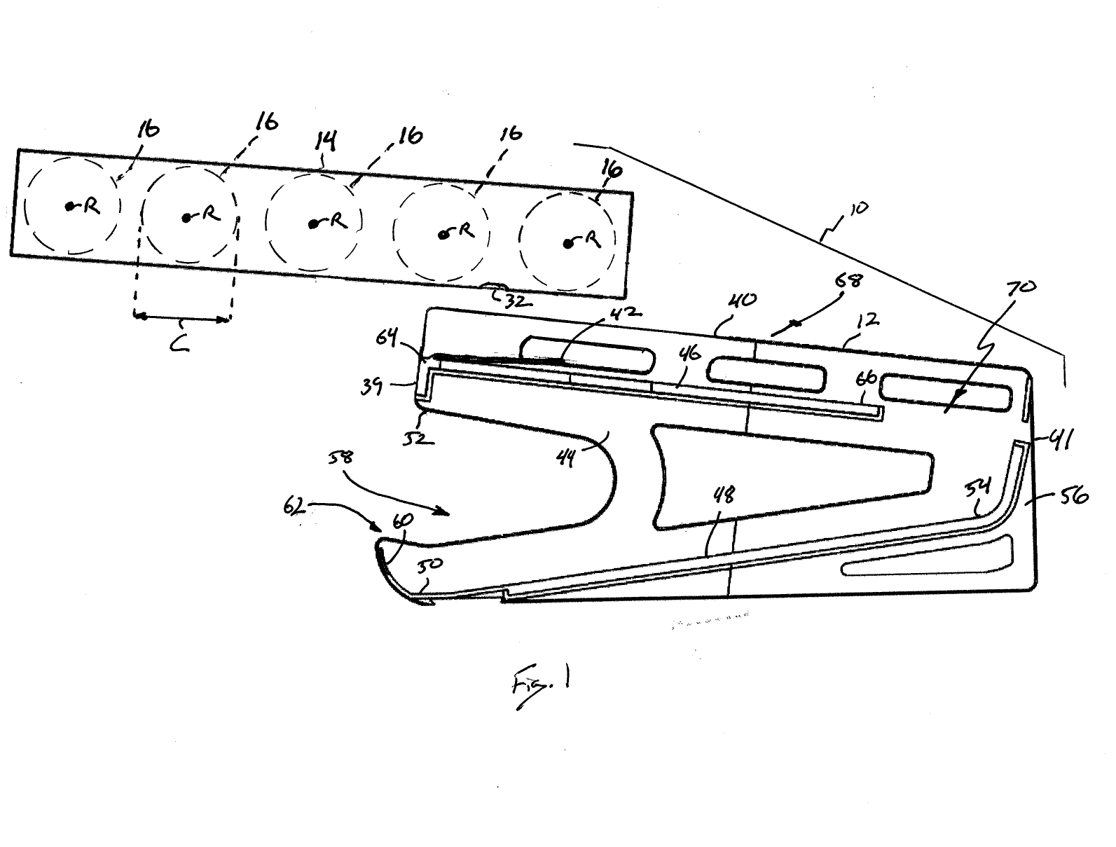

Referring to FIG. 1, one aspect of the disclosed product dispensing system, generally designated 10, may include a dispenser 12 and a container 14. The container 14 may house multiple units of product 16, such as cans (e.g., canned soup), jars (e.g., jarred sauce) or bottles (e.g., bottled soft drinks). Each product 16 may be positioned to roll relative to the container 14 about an associated rolling axis R. Therefore, when the container 14 is loaded onto the dispenser 12 in the manner described in greater detail below, the dispenser 12 may engage and open the container 14 to release the products 16 from the container 14 such that the products 16 may roll into the dispenser 12 under the force of gravity.

The container 14 may be any container capable of housing products 16 and beneficially interacting with the disclosed dispenser 12 to open the container 14 and release the products 16 from the container 14 to the dispenser 12. In one particular aspect, the container 14 may be formed from a paperboard-based material, such as C1S paperboard, which may have a coating (e.g., clay) on a first major surface thereof and an uncoated second major surface, or C2S paperboard, which may have a coating (e.g., clay) on both major surfaces thereof. Optionally, the exterior surface of the container 14 may be marked with various indicia, such as printed text and graphics.

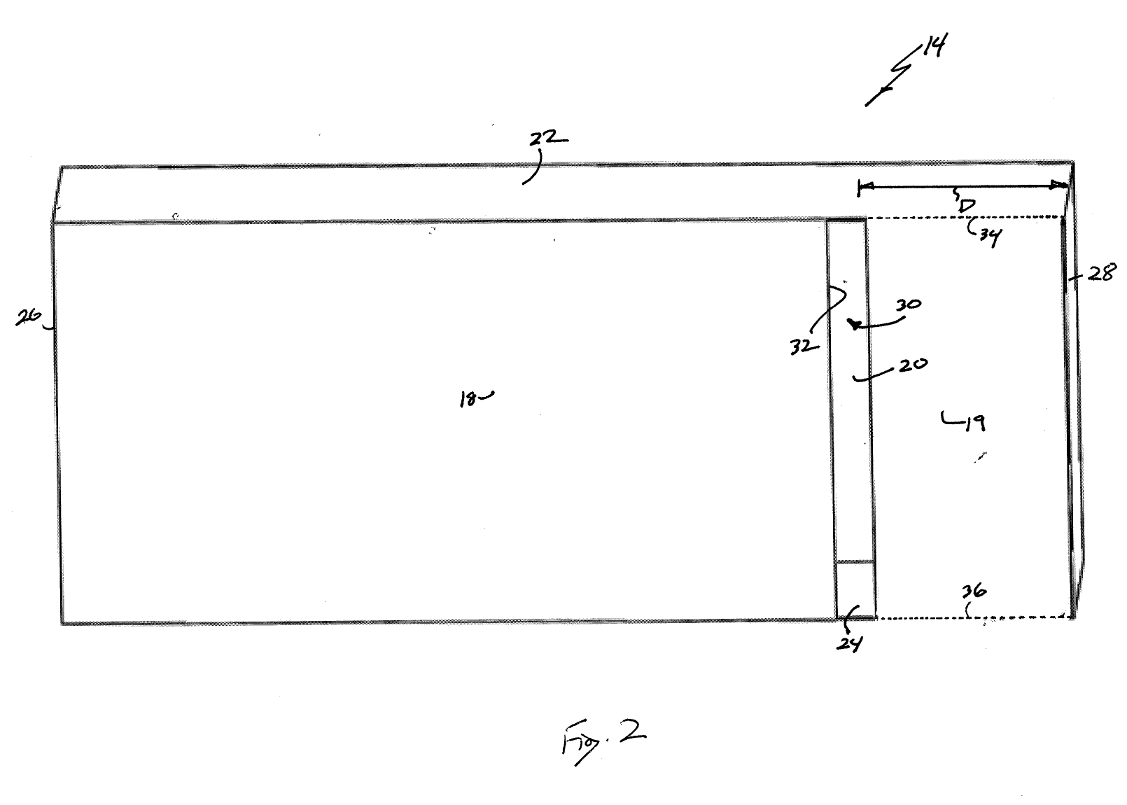

As shown in FIG. 2, the container 14 may be a generally rectilinear container having six walls 18, 20, 22, 24, 26, 28 that define an internal volume 30 of the container 14. Opposed walls 26 and 28 may define the front and rear walls, respectively, of the container 14. Opposed walls 22 and 24 may define the first (e.g., right) and second (e.g., left) side walls, respectively, of the container 14. Opposed walls 18 and 20 may define the base and upper walls, respectively, of the container 14.

Still referring to FIG. 2, the base wall 18 of the container 14 may define an opening 32 into the internal volume 30 of the container 14. The opening 32 may extend laterally between the side walls 22, 24 of the container 14 and may be spaced a distance D from the rear wall 28 of the container 14. The opening 32 may extend completely between the side walls 22, 24 of the container 14, or only partially between the side wall walls 22, 24. The distance D between the opening 32 and the rear wall 28 may be greater than the greatest diameter C (FIG. 1) of the products 16 housed in the container 14, such as about 1.5 times the greatest diameter C of the products 16.

In one expression, the opening 32 may be pre-formed in the container 14. In another expression, the opening 32 in the container 14 may be covered by a sealing tape or label (not shown) such that the opening 32 may be formed by pealing the sealing tape or label from the container 14 immediately prior to loading the container onto the dispenser 12. In yet another expression, the opening 32 in the container 14 may be formed by pulling zippered strip from the container 14 immediately prior to loading the container onto the dispenser 12.

Optionally, a first row of perforations 34 may extend generally longitudinally from the opening 32 to the rear wall 28 of the container 14 proximate the right side wall 22 of the container 14 and a second row of perforations 36 may extend generally longitudinally from the opening 32 to the rear wall 28 of the container 14 proximate the left side wall 24 of the container 14. As will be described in greater detail below, the first and second rows of perforations 34, 36 may effect a clean and simple separation of a portion of the base wall 18 from the side walls 22, 24 to open the container 14 and release the products 16 therefrom.

Those skilled in the art will appreciate that a wide variety of perforation types and perforation strengths (e.g., ties/teeth per inch) are known in the art, including standard perforations and micro perforations, and that variation in the type of perforations used will not constitute a departure from the scope of the present disclosure. Furthermore, those skilled in the art will appreciate that perforations 34, 36 are only one available technique for effecting such a separation of the base wall 18, and that any available technique that weakens the container 14 along the desired tear lines (34, 36), such as a score, crease or fold, may be used without departing from the scope of the present disclosure.

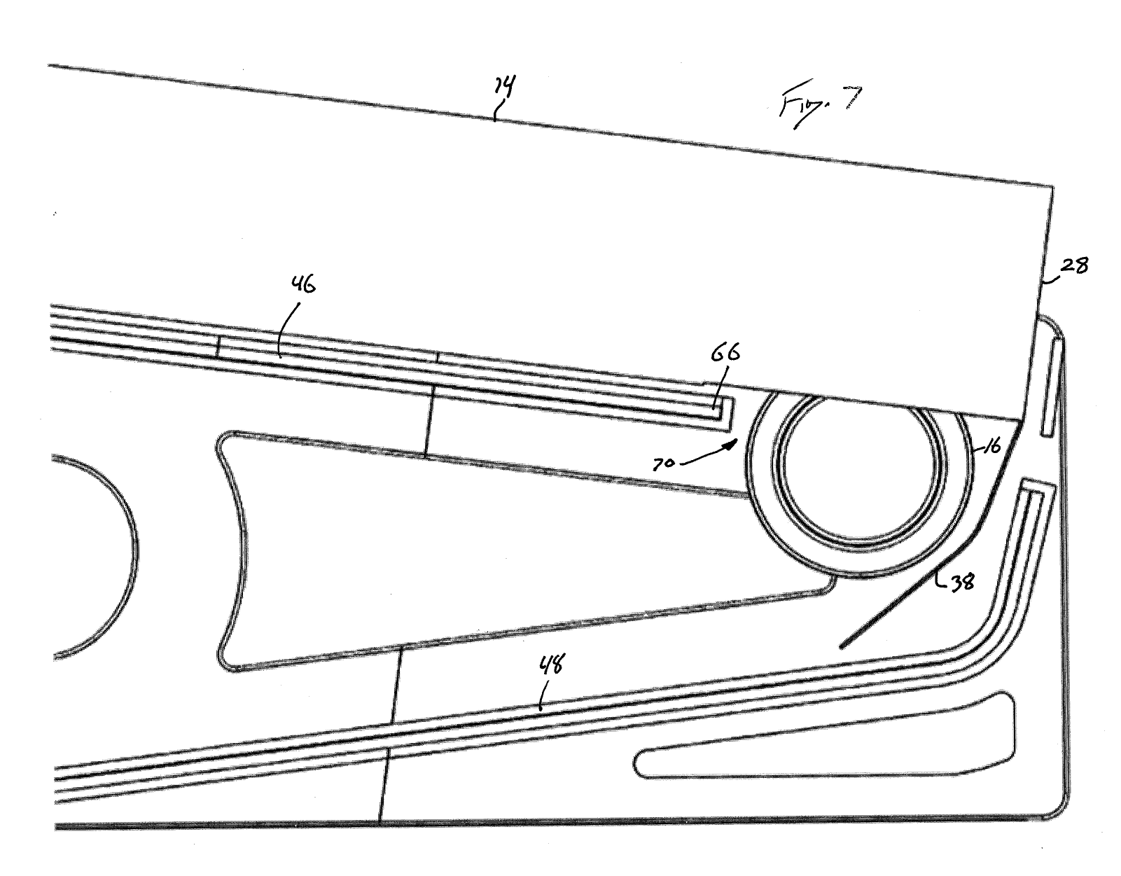

Thus, a pulling force applied to the rear end 19 of the base wall 18 at the opening 32 may separate the rear end 19 of the base wall 18 from the side walls 22, 24 along the first 34 and second 36 rows of perforations to form a flap 38 that is hingedly connected to the rear wall 28 of the container 14, as shown in FIG. 7.

Referring back to FIG. 1, the dispenser 12 may include a frame 40 for supporting the container 14 and the products 16 in a desired configuration and a catch element 42 for engaging the opening 32 in the container 14 to form the flap 38 which releases the products 16 from the container 14 to the dispenser 12. Those skilled in the art will appreciate that the dispenser 12 may include additional components and features, such as the components and features of the dispensers disclosed in U.S. Ser. No. 12/777,444, without departing from the scope of the present disclosure.

The frame 40 may have a front end 39 and a rear end 41 and may include a first side wall 44, a second side wall (not shown), an upper support deck 46 and a lower support deck 48. The second side wall may be structurally similar to the first side wall 44, but may be laterally opposed from the first side wall 44 and may be generally parallel with the first side wall 44.

The lower support deck 48 may extend longitudinally between the first 44 and second side walls, and may include a front end 50 that extends to the front ends 52 of the first 44 and second side walls and a rear end 54 that extends to the rear ends 56 of the first 44 and second side walls. Therefore, the lower support deck 48 and the first 44 and second side walls may define a lower level 58 of the frame 40.

The lower support deck 48 may be inclined from the front end 50 to the rear end 54 (i.e., the rear end 54 may be elevated relative to the front end 50) such that products 16 deposited proximate (i.e., at or near) the rear end 54 of the lower support deck 48 roll down to the front end 50 of the lower support deck 48 under the force of gravity. The extent of the incline of the lower support deck 48 may be dictated by, among other things, the coefficient of friction of the material used to form the frame 40 and the shape of the products 16 to be dispensed by the dispenser 12.

One or more stops 60 may be positioned proximate the front end 50 of the lower support deck 48 to prevent product 16 from rolling beyond the front end 50 of the lower support deck 48. For example, the stop 60 may be connected to (e.g., integral with) the lower support deck 48, and may be an upward curve at the front end 50 of the lower support deck 48. Therefore, the stop 60 may collect product 16 at the front end 50 of the lower support deck 48, thereby establishing a product display area 62 proximate the front end 50 of the lower support deck 48.

The upper support deck 46 may extend longitudinally between the first 44 and second side walls, and may include a front end 64 that extends to the front ends 52 of the first 44 and second side walls and a rear end 66 that extends toward, but not to, the rear ends 56 of the first 44 and second side walls, thereby defining an upper level 68 of the frame 40. The spacing between the rear end 66 of the upper support deck 46 and the rear ends 56 of the first 44 and second side walls may define an opening 70, which may function as a chute to allow product 16 to move from the upper level 68 to the lower level 58 of the frame 40.

The upper support deck 46 may be declined from the front end 64 to the rear end 66 (i.e., the front end 64 may be elevated relative to the rear end 66). Therefore, product 16 supported by the upper support deck 46 may roll under the force of gravity down to the rear end 66 of the upper support deck 46, through the opening 70 and, ultimately, to the lower level 58 of the frame 40.

The catch element 42 may be position on the upper level 68 of the frame 40 and may be connected to the frame 40 proximate the front end 64 of the upper support deck 46 to engage the container 14 as the container 14 is loaded onto the dispenser 12. The shape and position of the catch element 42 may be selected such that the catch element 42 may extend through the opening 32 in the container 14 to releasably engage (e.g., hold) the rear end 19 of the base wall 18 of the container 14 as the container 14 is loaded onto the upper support deck 46 of the frame 40 of the dispenser 12.

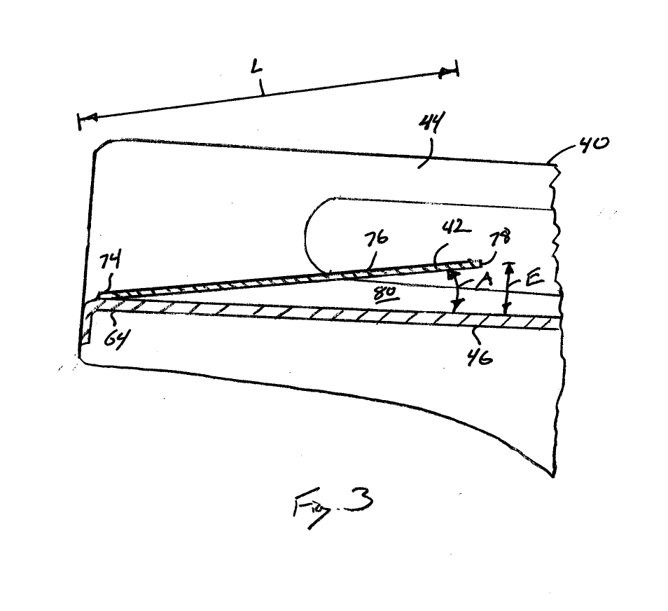

In one particular construction, the catch element 42 may be connected to the upper support deck 46 of the frame 40 proximate the front end 64 of the upper support deck 46. As shown in FIG. 3, the catch element 42 may include a base 74 and a protrusion 76. The base 74 may be fixedly connected to the front end 64 of the upper support deck 46. The protrusion 76 may be a generally flat, planar structure (e.g., a ramp) and may extend rearwardly (i.e., toward the rear end 66 (FIG. 1) of the upper support deck 46) from the base 74.

The protrusion 76 of the catch element 42 may extend laterally between the first 44 and second side walls of the frame 40 and may have a lateral width, which may be less than the lateral spacing between the first 44 and second side walls of the frame 40. As a non-limiting example, the lateral width of the protrusion 76 of the catch element 42 may be about 40 to about 80 percent of the lateral spacing of the first 44 and second side walls of the frame 40.

The protrusion 76 of the catch element 42 may be disposed at a non-zero angle A relative to the upper support deck 46 and may have a length L. Therefore, the proximal-most (i.e., rear-most) end 78 of the protrusion 76 may be elevated a distance E from the upper support deck 46.

The distance E between the proximal-most end 78 of the protrusion 76 and the upper support deck 46 may be of a sufficient magnitude to allow the rear end 19 of the base wall 18 to be positioned in the gap 80 between the protrusion 76 and the upper support deck 46. For example, the distance E between the proximal-most end 78 of the protrusion 76 and the upper support deck 46 may be greater than (e.g., 1.5 times or 2 times) the cross-sectional thickness of the base wall 18 of the container 14.

The angle A between the protrusion 76 and the upper support deck 46 may be dictated by the length L of the protrusion 76 and the desired spacing E between the proximal-most end 78 of the protrusion 76 and the upper support deck 46. Those skilled in the art will appreciate that the angle A may be sufficiently high so as to provide the desired spacing E, but sufficiently small so as not to significantly obstruct sliding movement of the container 14 along the upper support deck 46. For example, the angle A between the protrusion 76 and the upper support deck 46 may be greater than 1 degree, but less than 25 degrees, such as about 5 to about 10 degrees.

The length L of the protrusion 76 may be sufficient such that the protrusion 76 may extend through the opening 32 in the container 14 and into the internal volume 30 of the container 14 to engage the rear end 19 of the base wall 18 of the container 14. As an example, the length L of the protrusion 76 may closely correspond to the distance D between the opening 32 and the rear wall 28 of the container 14.

While the catch element 42 is shown and described as having a protrusion 76 formed as a generally flat, planar structure, those skilled in the art will appreciate that various alternative structures may be used as the disclosed catch element 42 without departing from the scope of the present disclosure. For example, alternative catch elements 42 including various hooks, protrusions, flanges, fingers, detents and the like are contemplated as being sufficient to engage the opening 32 in the container 14 and to peel back the rear end 19 of the base wall 18 of the container 14 while the container 14 is being loaded onto the dispenser 12.

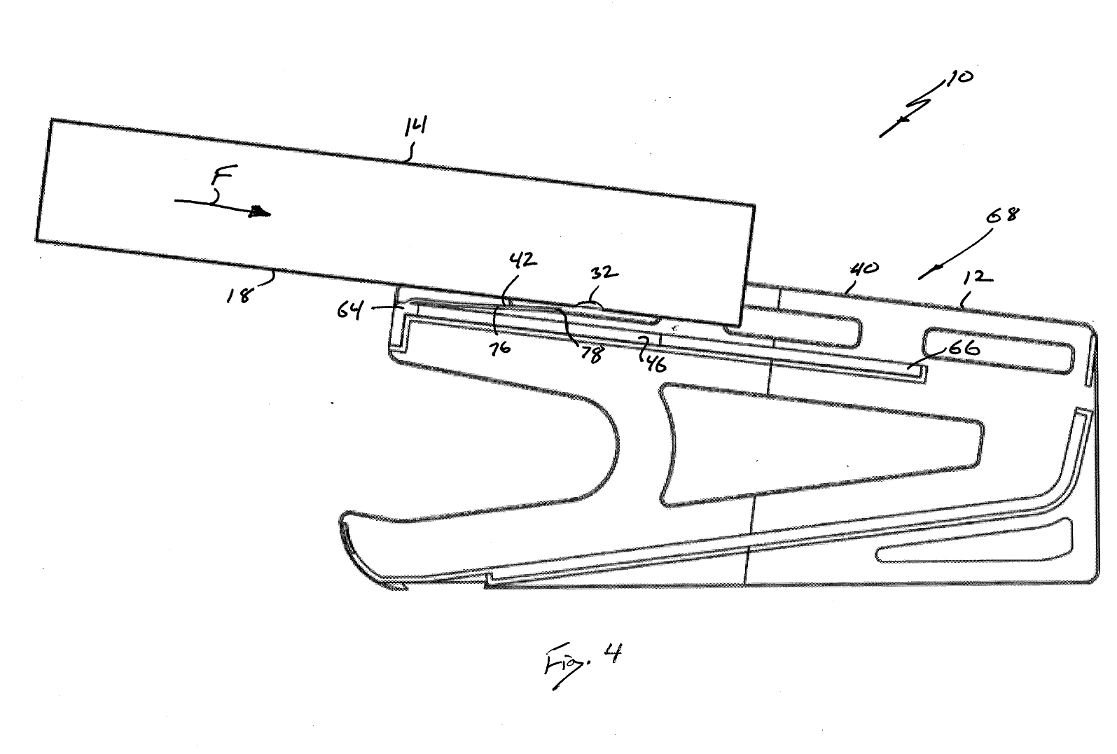

The container 14 may be loaded onto the dispenser 12 by urging the container 14 along the upper level 68 of the frame 40 in the proximal direction, as shown by arrow F in FIG. 4. As the container 14 is moved along the upper level 68 of the frame 40 from the front end 64 of the upper support deck 46 toward the rear end 66, the base wall 18 of the container 14 may slide along the catch element 42 until the opening 32 in the container 14 is positioned proximally beyond the proximal-most end 78 of the protrusion 76 of the catch element 42.

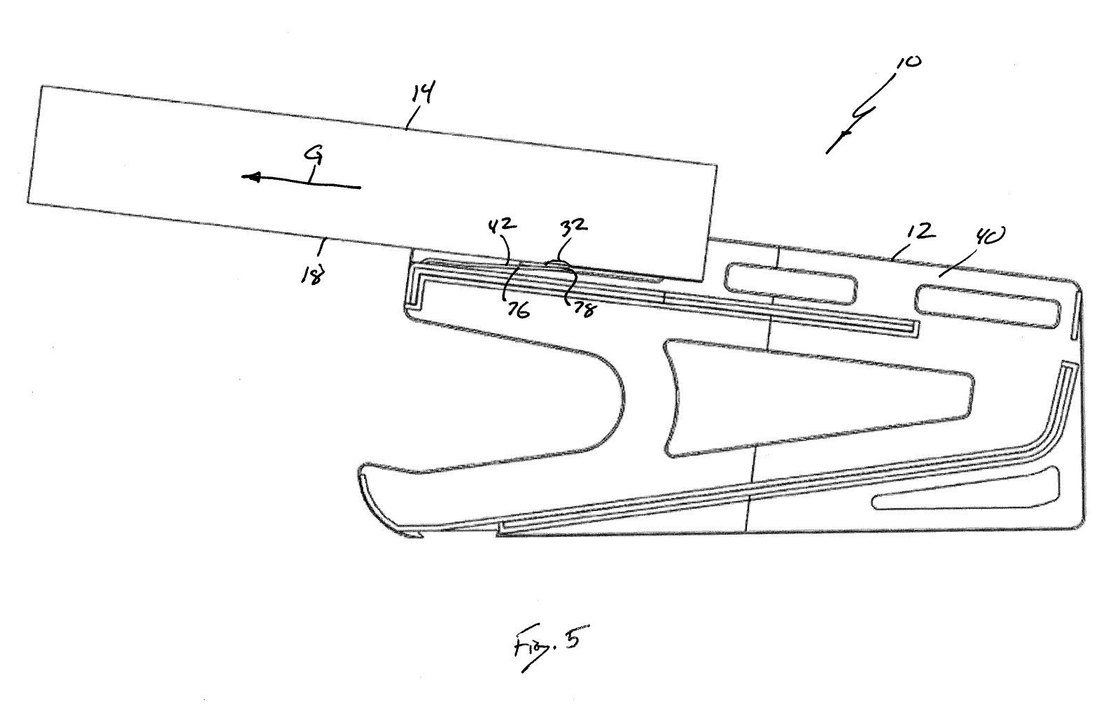

After the opening 32 in the container 14 has moved proximally beyond the proximal-most end 78 of the protrusion 76 of the catch element 42, the container 14 may then be partially withdrawn (arrow G) such that the proximal-most end 78 of the protrusion 76 is aligned with the opening 32, as shown in FIG. 5.

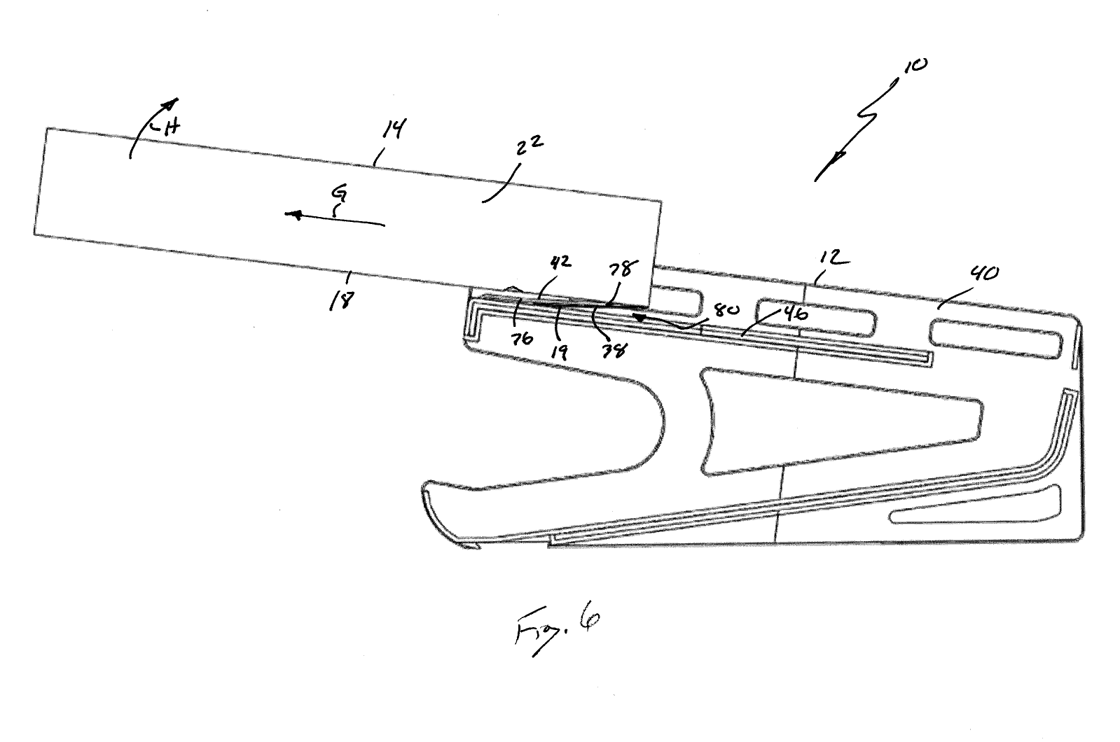

As shown in FIG. 6, as the container is further withdrawn (arrow G), the protrusion 76 of the catch element 42 is urged through the opening 32 in the container 14 such that the rear end 19 of the base wall 18 is urged into the gap 80 between the protrusion 76 and the upper support deck 46. As the rear end 19 of the base wall 18 is urged into the gap 80, the rear end 19 of the base wall 18 may begin to separate from the side walls 22, 24 (FIG. 2) of the container 14 (e.g., along the first 34 and second 36 row of perforations), thereby forming the flap 38. An optional pivoting motion of the container 14 relative to the dispenser 12, shown by arrow H, may complete separation of the rear end 19 of the base wall 18 from the side walls 22, 24. The engagement between the catch element 42 and the container 14 may inhibit further withdrawal of the container 14 in the direction shown by arrow G.

With the flap 38 formed, the container 14 may again be urged along the upper level 68 of the frame 40 in the proximal direction (arrow F in FIG. 4) from the front end 64 of the upper support deck 46 to the rear end 66. As the container 14 moves proximally beyond the rear end 66 of the upper support deck 46, the flap 38 may drop through the opening 70 defined by the upper support deck 46 such that the products 16 housed in the container 14 are released from the container 14 and move through the opening and to the lower level 58 of the dispenser 12, as shown in FIG. 7 and, ultimately, to the product display area 62 (FIG. 1).

Accordingly, the catch element 42 may engage the opening 32 in the container 14 and may peel away a portion of the base wall 18 of the container 14 to form the flap 38 as the container 14 is loaded onto the dispenser 12, thereby eliminating the need for opening the container 14 prior to loading the container 14 onto the dispenser 12.

Although various aspects of the disclosed product dispensing system have been shown and described, modifications may occur to those skilled in the art upon reading the specification. The present application includes such modifications and is limited only by the scope of the claims.

What is claimed is:

1. A product dispensing system comprising:
a container that defines an internal volume and an opening into said internal volume; and
a dispenser comprising:
a frame comprising an upper support deck having a front end and a rear end longitudinally opposed from said front end; and
a catch element connected proximate said front end, said catch element including a protrusion that extends toward said rear end such that said protrusion engages said opening when said container longitudinally moves along said upper support deck from said rear end toward said front end.

2. The product dispensing system of claim 1 further comprising a plurality of products received in said internal volume.

3. The product dispensing system of claim 1 wherein said container comprises paperboard.

4. The product dispensing system of claim 1 wherein said frame further comprises two opposed side walls.

5. The product dispensing system of claim 1 wherein said catch element is connected to said upper support deck.

6. The product dispensing system of claim 1 wherein said protrusion extends at a non-zero angle relative to said upper support deck.

7. The product dispensing system of claim 6 wherein said non-zero angle ranges from about 1 to about 25 degrees.

8. The product dispensing system of claim 6 wherein said non-zero angle ranges from about 5 to about 10 degrees.

9. The product dispensing system of claim 1 wherein said opening is formed in a base wall of said container, said base wall having a cross-sectional thickness.

10. The product dispensing system of claim 9 wherein said protrusion includes a rear-most end, and wherein a vertical distance between said rear-most end and said upper support deck is at most three times said cross-sectional thickness.

11. The product dispensing system of claim 10 wherein said vertical distance is at most two times said cross-sectional thickness.

12. The product dispensing system of claim 1 wherein said catch element comprises a base connected to said upper support deck, and wherein said protrusion extends from said base.

13. The product dispensing system of claim 1 wherein said front end is elevated relative to said rear end.

14. The product dispensing system of claim 1 further comprising a lower support deck positioned below said upper support deck, wherein said lower support deck defines a product display area.

15. A product dispensing system comprising:
a dispenser comprising:
a frame comprising an upper support deck having a front end and a rear end longitudinally opposed from said front end; and
a catch element connected to said front end and including a protrusion that extends toward said rear end at a non-zero angle relative to said upper support deck; and
a container positioned on said upper support deck, wherein said container defines an internal volume and an opening into said internal volume, said opening being positioned to be engaged by said protrusion when said container longitudinally moves along said upper support deck from said rear end toward said front end.

16. The product dispensing system of claim 15 further comprising a plurality of products received in said internal volume.

17. The product dispensing system of claim 15 wherein said catch element is connected to said front end.

18. The product dispensing system of claim 15 wherein said protrusion extends at a non-zero angle relative to said upper support deck.

19. The product dispensing system of claim 18 wherein said non-zero angle ranges from about 5 to about 10 degrees.

20. A method for dispensing a plurality of products comprising the steps of:
providing a dispenser comprising:
a frame comprising an upper support deck having a front end and a rear end longitudinally opposed from said front end; and
a catch element connected proximate said front end, said catch element including a protrusion that extends toward said rear end;
providing a container housing said plurality of products, said container defining an opening therein;
sliding said container longitudinally along said upper support deck toward said front end such that said protrusion engages said opening and opens said container; and
sliding said open container longitudinally along said upper support deck toward said rear end to allow said plurality of products to be at least partially dispensed from said open container.
